(19) United States
(12) Patent Application Publication
(10) Pub. No.: US 2013/0194314 A1
(43) Pub. Date: Aug. 1, 2013

(54) DESKTOP EXTENSION

(71) Applicant: Juha Arrasvuori, Tampere (FI)

(72) Inventor: Juha Arrasvuori, Tampere (FI)

(73) Assignee: NOKIA CORPORATION, Espoo (FI)

(21) Appl. No.: 13/358,746

(22) Filed: Jan. 26, 2012

(51) Int. Cl. G06F 3/041; G09G 5/00

(52) U.S. Cl. 345/684; 345/173

(57) ABSTRACT

In accordance with an example embodiment of the present invention, a method is provided, including detecting user applied twisting of an apparatus having a touch display that provides a desktop; and revealing a desktop extension on twist-direction side of the desktop in response to the detected twisting.

### TECHNICAL FIELD

The present application relates generally to extending the desktop in a device.

### BACKGROUND

Current mobile handheld devices, such as mobile phones, tablet PCs and PDA devices, cannot have very large displays due to the rather small size of the devices. A common problem in these devices is that the display area should be used effectively.

### SUMMARY

Various aspects of examples of the present invention are set out in the claims.

According to a first example aspect of the invention there is provided a method, comprising:

detecting user applied twisting of an apparatus having a touch display that provides a desktop; and

revealing a desktop extension on twist-direction side of the desktop in response to the detected twisting.

The twisted apparatus (or device) may be either deformable or rigid. In example embodiments in which the apparatus is deformable, the twisting may cause the apparatus to actually deform. In example embodiments in which the apparatus is rigid, the apparatus does not substantially deform. In the latter embodiments, when the user twists the device so as to deform it (although it does not deform), the user applied twisting can still be detected. One or more sensors may be used to detect the twisting in both type of embodiments.

In certain example embodiments, an extended desktop is formed by the desktop and the desktop extension. In certain example embodiments, the desktop extension is not in use (disabled) and the desktop cannot therefore be scrolled to reveal the desktop extension unless the desktop extension is revealed (activated) by said twisting.

In certain example embodiments, there are one or more alternative desktop extensions which reveal depending on the twist-direction. Certain example embodiments comprise accessing alternative desktop extensions from twist-direction side of a bendable device. In certain example embodiments, only one desktop extension can be in use at a time. In these embodiments, when for example the desktop with a left-hand side desktop extension form the extended desktop, another desktop extension, such as a right-hand side desktop extension is not in use during that time.

In certain example embodiments, the extended desktop is in use until the desktop extension is deactivated. In certain embodiments, deactivation of the desktop extension is performed by twisting the apparatus into the opposite direction. In other embodiments, the activation of the desktop extension is maintained only in response to continuous twisting to the corresponding direction.

In certain example embodiments, the apparatus provides right-hand side and left-hand side desktop extensions that are activated by twisting in corresponding direction. In certain example embodiments, the apparatus provides a top-side desktop extension that is revealed on the top-side of the desktop. In certain example embodiments, the top-side desktop extension is activated by twisting into the top direction. The top-side desktop extension may be in addition to one or more of other desktop extensions or it may be the only desktop extension.

In certain example embodiments, the revealing of the desktop extension additionally requires a user applied hover swipe. In certain example embodiments, the hover swipe is required in the twist-direction concerned. By the hover swipe is meant a non-touching swipe by a finger or similar above the touch display in accordance with hover sensing technology known as such.

In certain example embodiments, the method comprises:

scrolling an extended desktop formed by the desktop and the desktop extension based on user applied hover swipe.

In certain example embodiments, the extended desktop forms a wrap around space which can be scrolled by hover swiping.

In certain example embodiments, a touch on an object is configured to activate the object on the extended desktop. In certain example embodiments, the touch means the user touching the surface of the display.

In certain example embodiments, the method comprises:

activating an object of the extended desktop in response to user touching the object. An example of the object is an icon.

According to a second example aspect of the invention there is provided an apparatus, comprising:

a twist detection module configured to detect user applied twisting of the apparatus;

a touch display configured to provide a desktop; and

a control module configured to reveal a desktop extension on twist-direction side of the desktop in response to the detected twisting.

In certain example embodiments, there is a front desktop with alternative left-side and right-side extensions with different icons. In certain example embodiments, the apparatus allows twisting with one hand to either direction to access corresponding side desktop extension. In certain example embodiments, during twisting, hover sensing is used to scroll with finger between the front desktop and either-side desktop extensions. In certain example embodiment, a desktop extension or all desktop extensions have wrap-around space so they can be scrolled infinitely.

In certain example embodiments, the apparatus is configured to scroll an extended desktop formed by the desktop and the desktop extension based on user applied hover swipe. In certain example embodiments, the apparatus therefore comprises a touch hover sensor.

In certain example embodiments, a touch on an object is configured to activate the object on the extended desktop.

In certain example embodiments, the apparatus is configured to activate an object of the extended desktop in response to user touching the object.

In certain example embodiments, the apparatus is a handheld mobile communication device, such as a mobile phone, or another electrical device. In certain example embodiments, the apparatus is a rigid device. In certain other example embodiments, the apparatus is a bendable device.

In certain example embodiments, the twist detection module comprises one or more force (or pressure) sensors and a processing unit. In certain example embodiments, the control module comprises a processing unit with at least one processor and memory means. The control module and twist detection module may have parts in common.

According to a third example aspect of the invention there is provided a computer program or program product comprising a computer-readable medium bearing computer program code embodied therein for use with a computer, the computer program code comprising:

code for detecting user applied twisting of an apparatus having a touch display that provides a desktop; and

code for revealing a desktop extension on twist-direction side of the desktop in response to the detected twisting.

According to yet another example aspect of the invention there is provided an apparatus, comprising:

at least one processor; and

at least one memory including computer program code

the at least one memory and the computer program code configured to, with the at least one processor, cause the apparatus to perform at least the following:

detecting user applied twisting of an apparatus having a touch display that provides a desktop; and

revealing a desktop extension on twist-direction side of the desktop in response to the detected twisting.

According to yet another example aspect of the invention there is provided an apparatus, comprising:

means for detecting user applied twisting of an apparatus having a touch display that provides a desktop; and

means for revealing a desktop extension on twist-direction side of the desktop in response to the detected twisting.

Different non-binding example aspects and embodiments of the present invention have been illustrated in the foregoing. The above embodiments are used merely to explain selected aspects or steps that may be utilized in implementations of the present invention. Some embodiments may be presented only with reference to certain example aspects of the invention. It should be appreciated that corresponding embodiments may apply to other example aspects as well. Any appropriate combinations of the embodiments may be formed.

### BRIEF DESCRIPTION OF THE DRAWINGS

For a more complete understanding of example embodiments of the present invention, reference is now made to the following descriptions taken in connection with the accompanying drawings in which:

FIG. 1 shows an example embodiment of the invention where twist-direction is to right;

FIG. 2 shows an example embodiment of the invention where twist-direction is to left;

FIG. 3 shows a block diagram of an apparatus in accordance with an example embodiment of the invention; and

FIG. 4 shows a rough flow diagram showing a method in accordance with an example embodiment of the invention.

### DETAILED DESCRIPTION

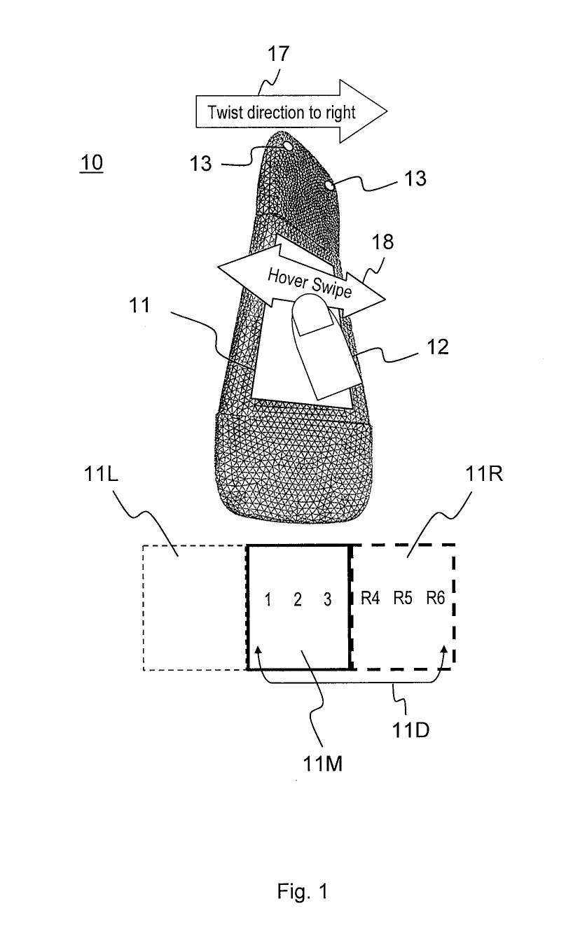

Example embodiments of the present invention and their potential advantages are understood by referring to FIGS. 1 through 4 of the drawings.

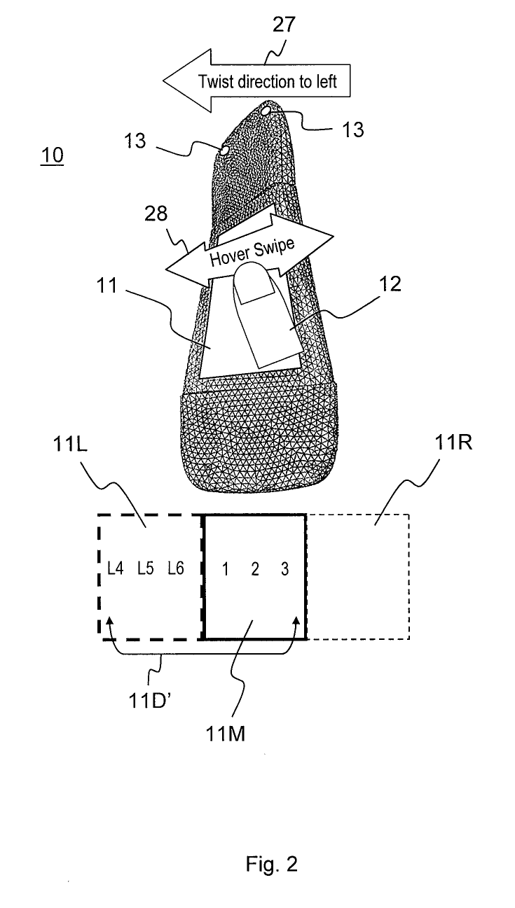

FIG. 1 shows a non-limiting example embodiment in which a bendable device 10 is twisted to right as indicated by arrow 17 to activate a right-hand side desktop extension 11R. And, FIG. 2 shows a corresponding example embodiment in which the bendable device 10 is twisted to left as indicated by arrow 27 to activate a left-hand side desktop extension 11L The bendable device 10 comprises at least one force sensor 13 for sensing the twist direction. The embodiments in FIGS. 1 and 2 show two force sensors 13 mounted close to the top corners of the device 10. The device 10 comprises a touch sensitive display 11. It contains, in this embodiment, in or close to the display 11 a touch hover sensor (not shown) for sensing movement of user's finger 12 above the display 11 although the finger 12 does not touch the display 11. These hover swipe movements in FIGS. 1 and 2 are depicted by arrows 18 and 28, respectively.

As mentioned, in addition to a front or main desktop 11M which is always accessible (or enabled), there are alternative left-side and right-side desktop extensions 11L and 11R with different icons. The icons typically represent objects such as applications, content items and/or data. The user may define which icon is associated with which desktop. For example, in FIG. 2, the main desktop 11M has icons 1, 2 and 3, the right-side desktop extension 11R has icons R4, R5 and R6 in FIG. 1, and the left-side desktop extension 11L has icons L4, L5 and L6. Although not illustrated, the same icon may appear both in the main desktop and an extension desktop.

In the initial phase, the right-side and left-side desktop extensions are disabled. The device 10 can be twisted with, for example, the left hand to either direction for accessing the corresponding side desktop extension. When the user applied force exceeds a predetermined threshold the desktop extension concerned becomes activated. The other desktop extension remains disabled. During twisting, hover sensing is used to scroll with, for example, a right-hand finger 12 between the main desktop and side desktop extension.

Both the main desktop and the desktop extensions may have wrap-around space so they can be scrolled infinitely. When for example in the embodiment of FIG. 1, the extended display is scrolled to the left, the next icon appearing after the leftmost icon 1 of the main display is the rightmost icon R6 of the right-side desktop extension. The wrap-around space in FIGS. 1 and 2 are depicted by reference numbers 11D and 11D′, respectively.

An icon, such as an icon of the front desktop, or an icon of a desktop extension, in these example embodiments is selected by touching the display 11.

In another example embodiment, the device 10 is a rigid device. The user can activate the side desktop extensions similarly as described in the foregoing, but the twisting does not result in deformation of the device like when twisting a bendable device. The force sensor(s) however can be used to detect the twist forces although the device does not visibly deform.

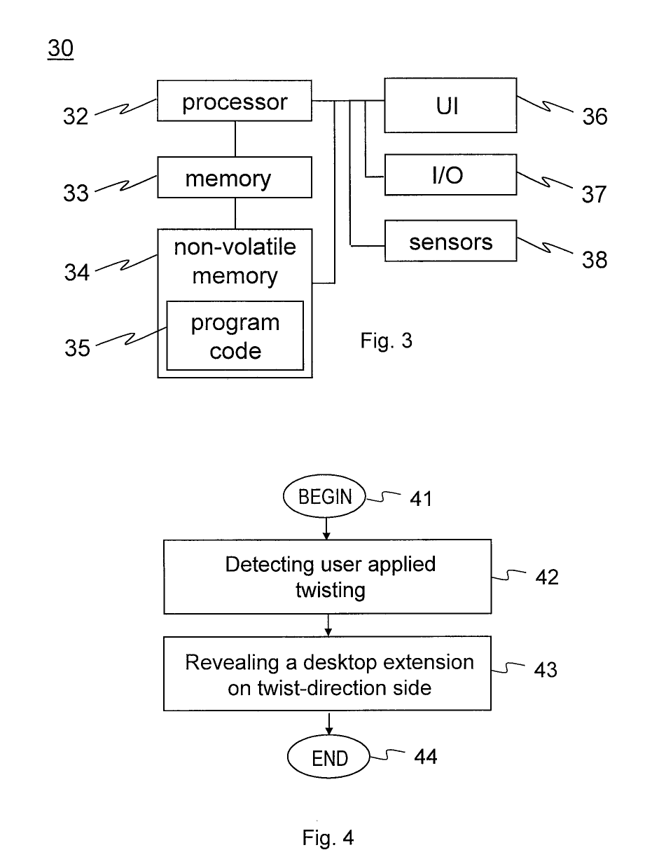

FIG. 3 shows an example block diagram of an apparatus 30 according to an example embodiment. The apparatus 30 comprises at least one non-volatile memory 34 configured to store computer programs or software comprising computer program code 35. The apparatus 30 further comprises at least one processor 32 for controlling the operation of the apparatus 30 using the computer program code 35, a work memory 33 for running the computer program code 35 by the at least one processor 32, and optionally an input/output system 37 for communicating with other entities or apparatuses. Accordingly, the input/output system 37, if present, comprises one or more communication units or modules providing communication interfaces towards a communication network, such as a mobile telecommunications network, and/or towards another apparatus.

The apparatus 30 comprises a user interface 36 enabling a user to use the device. The user interface 36 comprises the touch sensitive display described in the foregoing. The apparatus 30 further comprises force and a touch hover sensors 38 described in the foregoing. The sensors 38 are connected to the at least one processor 32. The sensors 38 together with the at least one processor 32 may form a twist sensing module, and the at least one processor 32 with memory means 33 and 34 a control module.

Depending on whether the apparatus 30 is a mobile communication device or another device, the structure of the apparatus may deviate from that presented in FIG. 3. One or more of the blocks may be omitted and/or one or more additional blocks may be added in an actual implementation.

FIG. 4 is a flow diagram showing a method in accordance with an example embodiment. The method begins at step 41. In step 42, the twisting direction of the device of user applied twisting is detected. In step 43, the desktop extension in the twist-direction side is enabled. The method ends at step 44.

Without in any way limiting the scope, interpretation, or application of the claims appearing below, certain technical effects of one or more of the example embodiments disclosed herein are listed in the following: A technical effect is a more efficient way to scroll through desktop than repeating swipes on a touch screen. A technical effect is that with one-hand twist interactions, the user's other hand is free for making selections. A technical effect is a natural use of the one-hand twist interaction. A technical effect is that the user is allowed to organize icons into one front desktop and one or more, for example two alternative desktops, that can be accessed conveniently by twisting the device to either direction and then be scrolled by hover swiping. A technical effect is twisting and hover sensing over conventional solutions that require multiple swipes on a touch screen to scroll through content that is outside the visible display. A technical effect is combining twisting and hover sensing for accessing alternative desktops.

The foregoing description has provided by way of non-limiting examples of particular implementations and embodiments of the invention a full and informative description of the best mode presently contemplated by the inventors for carrying out the invention. It is however clear to a person skilled in the art that the invention is not restricted to details of the embodiments presented above, but that it can be implemented in other embodiments using equivalent means or in different combinations of embodiments without deviating from the characteristics of the invention.

If desired, the different functions discussed herein may be performed in a different order and/or concurrently with each other. Furthermore, if desired, one or more of the above-described functions may be optional.

Furthermore, some of the features of the above-disclosed embodiments of this invention may be used to advantage without the corresponding use of other features. As such, the foregoing description shall be considered as merely illustrative of the principles of the present invention, and not in limitation thereof. Hence, the scope of the invention is only restricted by the appended patent claims.

1. A method, comprising:
detecting user applied twisting of an apparatus having a touch display that provides a desktop; and
revealing a desktop extension on twist-direction side of the desktop in response to the detected twisting.

2. The method of claim 1, comprising:
scrolling an extended desktop formed by the desktop and the desktop extension based on user applied hover swipe.

3. The method of claim 1, wherein a touch on an object is configured to activate the object on the extended desktop.

4. The method of claim 1, comprising:
activating an object of the extended desktop in response to user touching the object.

5. An apparatus, comprising:
a twist detection module configured to detect user applied twisting of the apparatus;
a touch display configured to provide a desktop; and
a control module configured to reveal a desktop extension on twist-direction side of the desktop in response to the detected twisting.

6. The apparatus of claim 5, wherein the apparatus is configured to scroll an extended desktop formed by the desktop and the desktop extension based on user applied hover swipe.

7. The apparatus of claim 5, wherein a touch on an object is configured to activate the object on the extended desktop.

8. The apparatus of claim 5, wherein the apparatus is deformable or rigid.

9. The apparatus of claim 5, wherein the apparatus is a handheld mobile communication device.

10. A computer program product comprising a computer-readable medium bearing computer program code embodied therein for use with a computer, the computer program code comprising:
code for detecting user applied twisting of an apparatus having a touch display that provides a desktop; and
code for revealing a desktop extension on twist-direction side of the desktop in response to the detected twisting.
